(19) United States
(12) Patent Application Publication
(10) Pub. No.: US 2026/0085723 A1
(43) Pub. Date: Mar. 26, 2026

(54) BEARING DEVICE WITH INTEGRATED ELECTRICAL INSULATION, NOTABLY FOR AN ELECTRIC MOTOR OR MACHINE, AND ASSOCIATED MANUFACTURING METHODS

(71) Applicant: AKTIEBOLAGET SKF, GOTEBORG (SE)

(72) Inventors: Mickael CHOLLET, Joué-Lès-Tours (FR); Anthony SIMONIN, Tours (FR); Benoit ARNAULT, Saint-Cyr-sur-Loire (FR)

(21) Appl. No.: 19/220,267

(22) Filed: May 28, 2025

(30) Foreign Application Priority Data
Jun. 6, 2024 (FR) 2405942

(51) Int. Cl. F16C 33/58; F16C 19/06; F16C 41/00

(52) U.S. Cl. CPC F16C 33/583; F16C 19/06; F16C 41/002; F16C 2380/26

(57) ABSTRACT

A bearing device includes a bearing having first and second rings, a bushing and an electrically insulating insert overmolded between and connecting the bushing and the second ring. A key is mounted in aligned slots of the bushing, the insert and the second ring to lock them against relative rotation. The key includes a retaining pin, at least one circumferentially extending support member connected to the retaining pin, and at least one radial bead on the circumferentially extending support member projecting into a radially facing groove to form an interference fit and hold the retaining pin in the slots of the bushing, insulating insert and the second ring.

### CROSS-REFERENCE

This application claims priority to French patent application no. 2405942 filed on Jun. 6, 2024, the contents of which are fully incorporated herein by reference.

### TECHNOLOGICAL FIELD

The present disclosure relates to the field of bearings that are used in particular in electric motors, electric machines and associated equipment.

### BACKGROUND

In an electric motor or machine, at least one rolling bearing is mounted between the casing of the electric motor or machine and the rotary shaft in order to support this shaft. During operation, when the shaft is rotating, a difference in electrical potential can arise between the shaft and the casing of the electric motor or machine, thereby generating an electric current between the inner ring of the rolling bearing, which is integral with the shaft, and the outer ring, which is integral with the casing. The electric current flowing through the components of the rolling bearing can damage these components, notably the rolling elements and raceways provided on the inner and outer rings. Electrical discharges can also generate vibrations.

To overcome these drawbacks, it is known to replace the rolling elements of the bearing, which are made of the same steel as the inner and outer rings, with rolling elements made of ceramic. The expression “hybrid rolling bearing” is then generally used. However, such a hybrid rolling bearing is relatively expensive.

In order to overcome the aforementioned drawbacks, it is also known to equip the outer ring of the rolling bearing with an insulating sleeve provided with a bushing and with an insulating insert made of electrically insulating material and interposed radially between the outer ring and the bushing. In order to attach the insulating insert to the outer ring and to the bushing without any additional elements or specific machining on the outer ring, the insulating insert can be overmolded. However, with such a solution, the insulating insert and the bushing may become detached from one another during operation.

### SUMMARY

The present disclosure therefore aims to overcome the aforementioned drawbacks by providing a bearing device which has a simple and economical design. The disclosure relates to a bearing device comprising a bearing having a first ring and a second ring able to rotate relative to each other. The device further comprises at least one insulating sleeve mounted on the second ring of the bearing. The insulating sleeve has a bushing and with an insulating insert interposed radially between the second ring of the bearing and the bushing. The insulating insert is made of electrically insulating material.

The bushing has an outer surface and an inner surface, opposite the outer surface, which delimit the radial thickness of the bushing. The insulating insert is overmolded on the second ring of the bearing and at least on one of the outer and inner surfaces of the bushing.

According to a general feature, at least one first slot is provided on the bushing. According to another general feature, at least one first slot is provided on the insulating insert. This first slot of the insulating insert is located at least partially in the radial continuation of the first slot of the bushing.

According to another general feature, at least one first slot is provided on the second ring of the bearing. This first slot of the second ring is located in the radial continuation of the first slot of the insulating insert.

According to yet another general feature, the device further comprises at least one anti-rotation device provided with at least one first retaining pin at least partially seated inside the first slots of the bushing, the insulating insert and the second ring of the bearing.

“Retaining pin at least partially seated inside the slot” means a retaining pin which is seated directly inside the slot, or indirectly inside the slot with an interposed intermediate element, for example a part of the insulating insert.

The anti-rotation device is further provided with a support on which the first retaining pin is mounted, and at least one axial retaining member of the anti-rotation device which cooperates with at least one of the second ring of the bearing, the insulating insert and the bushing. This provides a bearing device that has integrated electrical insulation and is economical compared to conventional hybrid rolling bearings. Furthermore, the device is easy to manufacture and assemble in the associated electric motor or machine.

Moreover, the provision of the anti-rotation device enables the bushing, the insulating insert and the second ring of the bearing to be made integral in the circumferential direction. The risk of relative movements between the insulating insert, the bushing and the second ring in the circumferential direction is limited, notably in the event of temperature variations.

“Circumferential direction” means the direction perpendicular both to the axial direction and to a radius of the bearing device, in other words tangential to a circle centered on the axis of the bearing device.

“Axial direction” means the direction parallel to the axis of the bearing device.

“Retaining pin” means an element that enables the bushing to be made integral with the insulating insert and which may be of any shape in cross section, for example polygonal such as square, rectangular, or also circular, oval, half-moon, etc.

The anti-rotation device may be made at least in part of electrically insulating material. Alternatively, the anti-rotation device may be made of electrically conductive material if it is surrounded, at least at one end, by an electrically insulating material.

The axial retaining member of the anti-rotation device may be arranged on the support. Alternatively, the axial retaining member may be arranged on the first retaining pin.

According to a particular embodiment, the axial retaining member cooperates by forming a snap fit with at least one of the second ring of the bearing, the insulating insert and the bushing, and preferably with at least one slot of one of the second ring of the bearing, the insulating insert and the bushing.

According to a particular embodiment, the support of the anti-rotation device is annular. In this case, the anti-rotation device may be further provided with at least a second retaining pin mounted on the support and seated at least partially inside second slots of the bushing, the insulating insert and the second ring of the bearing, the second slot of the insulating insert being located at least partially in the radial continuation of the second slot of the bushing and the second slot of the second ring being located in the radial continuation of the second slot of the insulating insert.

According to a particular design, the support of the anti-rotation device extends nearly as far as the first ring to form a dynamic annular seal with the first ring. “Dynamic seal” means the seal made between two parts in relative motion.

The bushing may also have two opposite radial end faces which delimit the axial length of the bushing. The insulating insert may have two opposite radial end faces which delimit the axial length of the insert. The first slot of the bushing may be formed on one of the end faces thereof. The first slot of the insulating insert may be formed on one of the end faces thereof. The first slot of the second ring of the bearing may be formed on one of the end faces of the second ring.

The anti-rotation device may be flush with or set back from the end face of the bushing, the end face of the insulating insert and the end face of the second ring of the bearing. Alternatively, the anti-rotation device may project axially from the end face of the bushing, the end face of the insulating insert and the end face of the second ring of the bearing. In this case, the anti-rotation device may extend into a slot formed in the casing inside which the bearing device is mounted to prevent the bearing device from rotating relative to the casing.

If the insulating insert is made of a synthetic or elastomeric material, the device is less sensitive to temperature variations.

In a particular embodiment, the bushing is made of metal. The bushing can thus be easily machined to a predetermined radial tolerance.

In one embodiment, the insulating insert covers the whole of the surface of the bushing. In this case, the insulating insert completely covers the surface of the bushing in the axial direction and in the circumferential direction.

According to a first design, the bushing delimits the outer surface of the device. In this case, the second ring is the outer ring of the bearing.

According to an alternative second design, the bushing delimits the inner surface of the device. In this case, the second ring is the inner ring of the bearing.

In a particular embodiment, the bearing comprises at least one row of rolling elements arranged between raceways of the first and second rings. The rolling elements may be made of metal.

The disclosure also relates to an electric motor comprising a casing, a shaft and at least one bearing device as defined above and mounted radially between the casing and the shaft.

### BRIEF DESCRIPTION OF THE DRAWINGS

The present disclosure will be better understood on studying the detailed description of embodiments, given by way of non-limiting example and illustrated by the appended drawings, in which:

FIG. 1 is an axial sectional view of a portion of a bearing device according to a first exemplary embodiment of the present disclosure.

FIG. 2 is a front elevational view of the bearing device in FIG. 1.

FIG. 3 is a partial sectional view along the line III-III of FIG. 2.

FIG. 4 is a perspective view of the bearing device of FIG. 2.

FIG. 5 is a partially exploded perspective view of the bearing device of FIG. 2.

FIG. 6 is a detail view of a portion of FIG. 5.

FIG. 7 is a perspective view of an anti-rotation device of the bearing device of FIG. 2.

FIG. 8 is a flowchart illustrating a first method for manufacturing the bearing device of FIG. 2.

FIG. 9 is a flowchart illustrating a second method for manufacturing the bearing device of FIG. 2.

FIG. 10 is a perspective view of a bearing device according to a second exemplary embodiment of the present disclosure.

FIG. 11 is a partially exploded perspective view of the bearing device of FIG. 10,

FIG. 12 is a perspective view of a bearing device according to a third exemplary embodiment of the present disclosure.

FIG. 13 is a partially exploded perspective view of the bearing device of FIG. 12.

FIG. 14 is an axial sectional view of the bearing device of FIG. 12.

### DETAILED DESCRIPTION

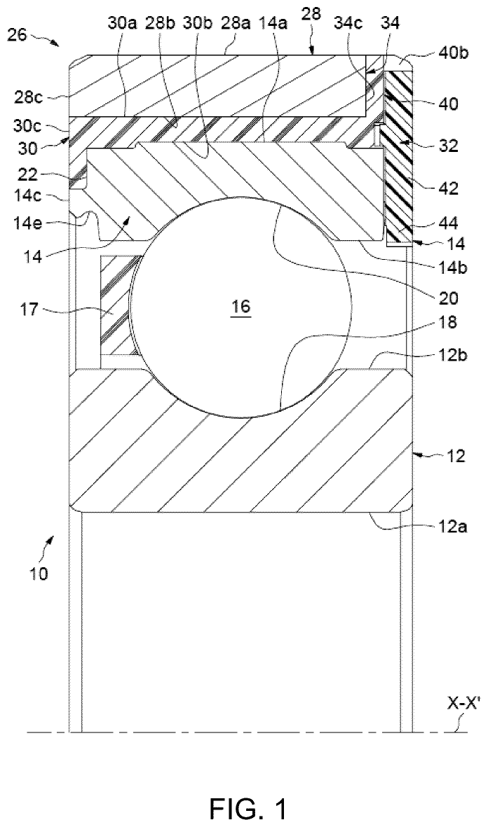

The bearing device illustrated in FIG. 1 comprises a bearing 10 having a first ring 12 and a second ring 14 that are configured to rotate relative to each other about the axis X-X′ of the bearing. In the exemplary embodiment illustrated, the first ring 12 is the inner ring of the bearing and the second ring 14 is the outer ring. The bearing device is designed such that it does not conduct electric currents. The bearing device has integrated electrical insulation.

The inner ring 12 and the outer ring 14 of the bearing are concentric and extend axially along the axis X-X′ of the bearing. The inner ring 12 and the outer ring 14 are made of steel. The rings are solid.

In the exemplary embodiment illustrated, the bearing 10 also comprises a row of rolling elements 16, in this case balls, interposed radially between the inner ring 12 and the outer ring 14. The rolling elements 16 are made of steel. The bearing 10 also comprises a cage 17 for maintaining the even circumferential spacing of the rolling elements 16. The bearing 10 can also be equipped with sealing flanges or gaskets.

The inner ring 12 has a cylindrical bore 12a, a cylindrical axially extending outer surface 12b radially opposite the bore, and two opposite radially extending end faces (not referenced) that axially delimit the bore 12a and the outer surface 12b. The bore 12a and the outer surface 12b delimit the radial thickness of the inner ring 12. The bore 12a forms the inner surface of the inner ring. The inner ring 12 also has an inner raceway 18 for the rolling elements 16 that is formed on the outer surface 12b. The raceway 18 is oriented radially outwards.

The outer ring 14 comprises a cylindrical axially extending outer surface 14a, a cylindrical bore 14b radially opposite the outer surface 14a, and two opposite radially extending end faces 14c, 14d axially delimiting the bore. The outer surface 14a and the bore 14b delimit the radial thickness of the outer ring 14. The bore 14b has a stepped shape. In the exemplary embodiment illustrated, the outer surface 14a of the ring has two distinct diameters. Alternatively, the outer surface 14a could have a single diameter. The outer ring 14 further includes an outer raceway 20 for the rolling elements 16 that is formed on the bore 14b. The raceway 20 is oriented radially inwards.

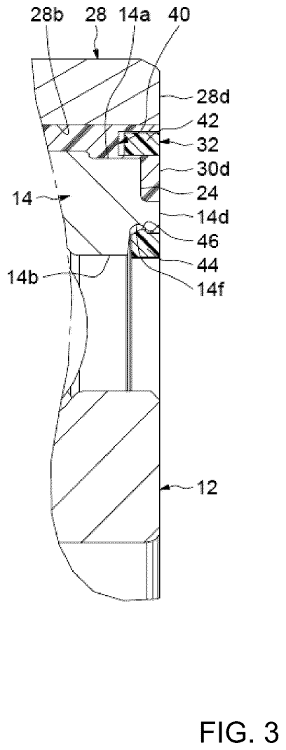

The outer ring 14 also comprises two annular grooves 14e, 14f (FIGS. 1 and 3) formed on the bore 14b, extending radially outwards and arranged axially on both sides of the rolling elements 16.

In the exemplary embodiment illustrated, a groove 22 is provided on the end face 14c of the outer ring. The groove 22 is oriented and open axially towards the outside of the outer ring. The groove 22 has a bottom that is axially offset towards the inside of the ring relative to the end face 14c. The bottom of the groove 22 forms a shoulder. The bottom of the groove 22 extends radially in this case for ease of manufacture. The groove 22 is annular in this case.

Similarly, a groove 24 is provided on the end face 14d of the outer ring. The groove 24 is oriented and open axially towards the outside of the outer ring. The groove 24 has a bottom that is axially offset towards the inside of the ring relative to the end face 14d. The bottom of the groove 24 forms a shoulder. The bottom of the groove 24 extends radially in this case. The groove 24 is annular in this case. The grooves 22, 24 are symmetrical with each other relative to a radial midplane of the outer ring. The grooves 22, 24 axially delimit the outer surface 14a.

The bearing device also comprises an electrically insulating sleeve 26 mounted on the outer surface 14a of the outer ring 14. The insulating sleeve 26 is integral with the outer ring 14.

The insulating sleeve 26 comprises a bushing 28 and an insulating insert 30 interposed radially between the outer ring 14 and the bushing 28. The insulating insert 30 is overmolded on the outer ring 14 and on the bushing 28.

As described in greater detail below, the bearing device also comprises a first and a second anti-rotation device 32, 33, sometimes referred to herein as “keys,” to constrain the bushing 28, the insulating insert 30 and the outer ring 14 of the bearing to rotate together.

The bushing 28 is annular. The bushing 28 extends axially. The bushing 28 is formed in one piece in this case. Alternatively, the bushing 28 could be made of multiple parts bearing against one another, for example two identical parts. The bushing 28 has a cylindrical annular axially extending outer surface 28a, and an annular bore 28b radially opposite the outer surface 24a. The bore 28b forms the inner surface of the bushing 24. The bore 28b is oriented radially inwards, i.e. towards the outer ring 14.

The bushing 28 also has two axially opposite radially extending end faces 28c, 28d axially delimiting the bore 28b and the outer surface 28a. The end faces 28c, 28d delimit the axial length of the bushing. The outer surface 28a and the bore 28b delimit the radial thickness of the bushing 24. The outer surface 28a of the bushing delimits the outer surface of the bearing device 10. In other words, the outer surface 28a defines the outer diameter of the bearing device 10.

In the exemplary embodiment illustrated, the end faces 28c, 28d of the bushing are coplanar with the end faces 14c, 14d of the outer ring, respectively. Alternatively, other arrangements could be provided. For example, the bushing 28 could have a smaller or greater axial dimension and be axially set back from the faces 14c, 14d of the outer ring, or could project from the faces.

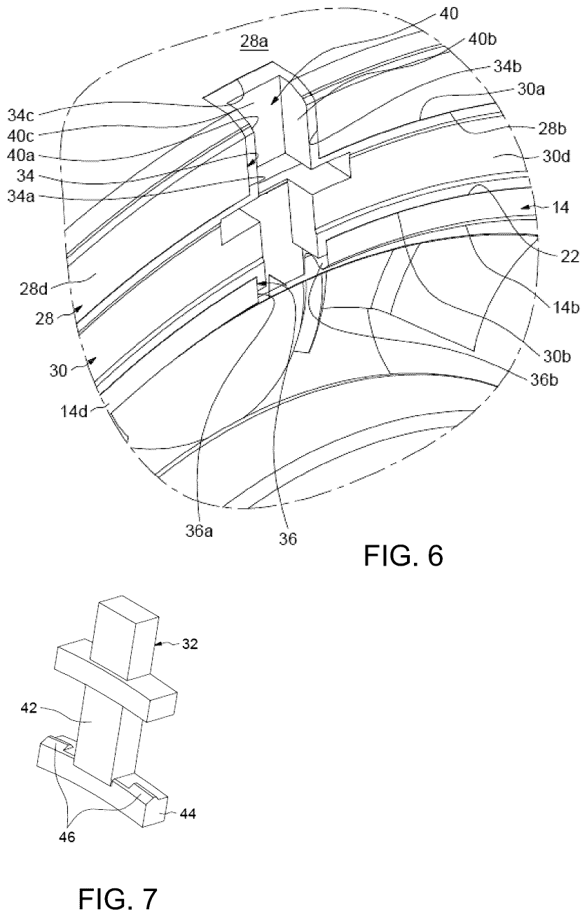

With reference to FIG. 6, a first slot 34 is formed on the end face 28d of the bushing and is oriented and open axially outwards. The slot 34 also opens radially into the bore 28b of the bushing. In the exemplary embodiment illustrated, the slot 34 also opens radially onto the outer surface 28a of the bushing.

The slot 34 is delimited in the circumferential direction by two opposing lateral flanks 34a, 34b which are connected together by a radially extending, axially facing bottom 34c. The flanks 34a, 34b are in this case rectilinear and extend radially. The bottom 34c also extends radially and is oriented axially outwards. Alternatively, the slot 34 could have no bottom, with the flanks 34a, 34b being joined directly together.

In the exemplary embodiment illustrated, a first slot 36 is formed on the outer ring. The slot 36 is formed on the outer surface of the groove 22 of the outer ring and opens onto the end face 14d and into the bore 14b. The slot 36 is open axially outwards. The slot 36 is open radially outwards and inwards. The slot 36 is open-ended in the radial direction. The slot 36 is delimited in the circumferential direction by two flanks 36a, 36b.

The insulating insert 30 is made of electrically insulating material. The insulating insert 30 can for example be made of a synthetic material, such as PEEK or PA46, or else be made of an elastomeric material, such as rubber.

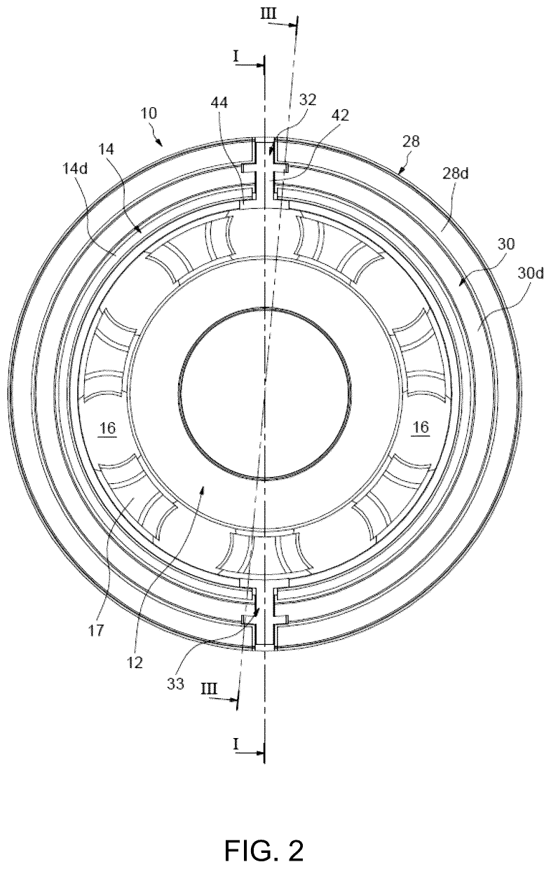

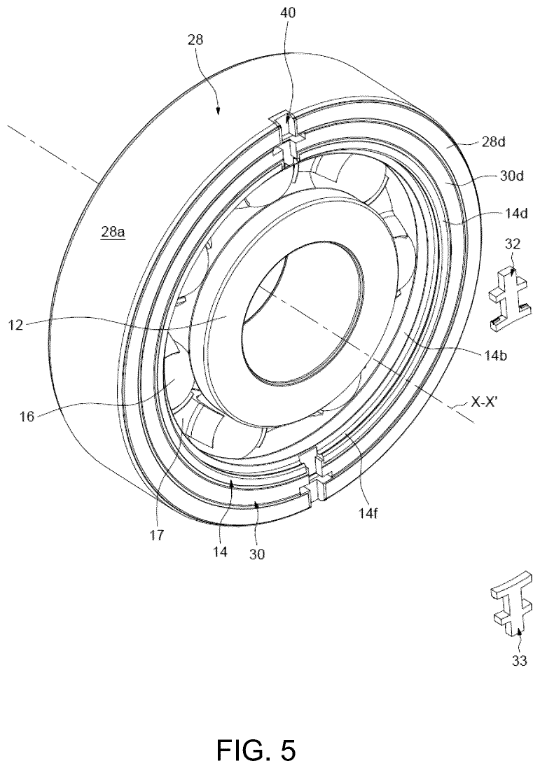

With reference to FIGS. 1 to 6, the insulating insert 30 is interposed radially between the outer surface 14a of the outer ring and the bore 28b of the bushing. The insulating insert 30 covers the outer surface 14a of the outer ring. The insulating insert 30 in this case entirely covers the outer surface 14a in the axial and circumferential directions. The insulating insert 30 also covers the grooves 22, 24 of the outer ring. The insulating insert 30 also partially covers the slot 36 of the outer ring. The insulating insert 30 partially covers the flanks 36a, 36b of the slot 36.

The insulating insert 30 also covers the bore 28b of the bushing. The insulating insert 30 in this case also entirely covers the bore 28b in the axial and circumferential directions. The insulating insert 30 also covers the slot 34 of the bushing. The insulating insert 30 covers the flanks 34a, 34b, and the bottom 34c of the slot.

The insulating insert 30 is annular. The insulating insert 30 extends axially. The insulating insert 30 comprises a cylindrical axially extending outer surface 30a, a cylindrical bore 30b radially opposite the outer surface 30a, and two opposite radially extending axially facing end faces 30c, 30d axially delimiting the bore and the outer surface. The radial end faces 30c, 30d delimit the axial length of the insulating insert 30. The outer surface 30a is in radial contact with the bore 28b of the bushing. The part of the insulating insert 30 which covers the slot 34 forms a protuberance which extends radially outwards. The bore 30b is in radial contact with the outer surface 14a of the outer ring and with the grooves 22, 24. The bore 30b has a stepped shape. The part of the insulating insert 30 which covers the slot 36 forms a protuberance which extends radially inwards.

In the exemplary embodiment illustrated, the faces 14c, 30c, 28c and 14d, 30d, 28d of the outer ring, of the insulating insert and of the bushing are respectively coplanar. As an alternative, other arrangements can be provided. For example, the insulating insert 30 could have a reduced axial dimension and be axially set back from the faces 14c, 14d of the outer ring. Alternatively, the insulating insert 30 could have a greater axial dimension and axially project from the faces 14c, 14d of the outer ring. In this case, the insulating insert 30 can at least partially cover these faces 14c, 14d. As a variant, the insulating insert 30 could at least partially cover the faces 28c, 28d of the bushing.

In another alternative, or in combination, the bushing 28 could axially project from the insulating insert 30 relative to the faces 30c and 30d, or could be axially set back from these faces.

Again with reference to FIG. 6, the insulating insert 30 also comprises a first slot 40 which is formed in the part of the insert which covers the slot 34 of the bushing and which forms the outward protuberance. A part of the slot 40 extends in the radial continuation of the slot 34. The slot 40 extends in the radial thickness of the insert. The slot 40 is open radially on the outer side and radially on the inner side. The slot 36 of the outer ring of the bearing is located in the radial continuation of the slot 40. The slot 40 is oriented and open axially outwards. The slot 40 opens onto the end face 30d of the insulating insert.

The slot 40 is delimited in the circumferential direction by two opposing lateral flanks 40a, 40b which are connected together by a radially extending, axially facing bottom 40c. In this case, seen from the front, the slot 40 has an overall cross shape. Alternatively, the slot 40 could have another shape, for example a parallelepiped shape. In this case, the flanks 40a, 40b are rectilinear.

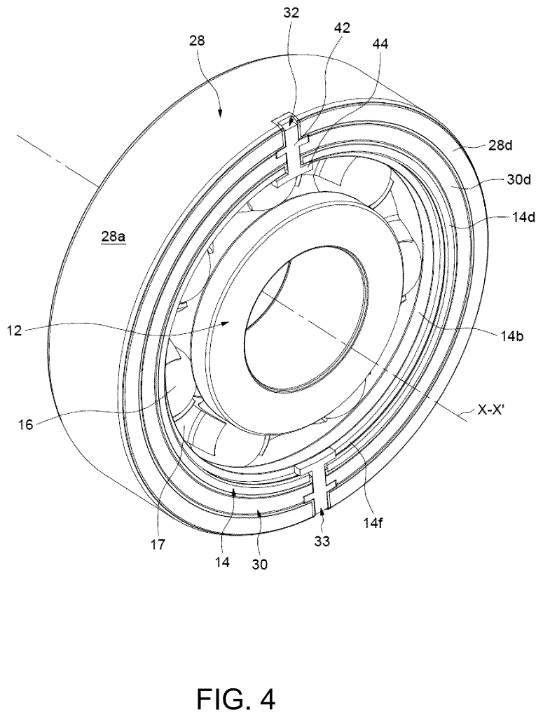

As indicated above, the bearing device includes the anti-rotation device (key) 32. With reference to FIGS. 4, 6 and 7, the anti-rotation device 32 has a retaining pin 42 and a circumferentially extending support member 44 from which the pin extends. The support member 44 is seated in the bore 14b of the outer ring of the bearing. More precisely, the support member 44 is seated in the groove 14f of the bore 14b.

The retaining pin 42 is mounted inside the slot 40 of the insulating insert. The retaining pin 42 is mounted indirectly inside the slot 34 of the bushing with the part of the insulating insert delimiting the slot 40 between the retaining pin and the slot 34. The retaining pin 42 bears against the flanks 40b, 40c of the slot 40 of the insulating insert in the circumferential direction. The shape of the retaining pin 42 matches the shape of the slot 40 of the insulating insert. In the exemplary embodiment illustrated, the pin 42 is therefore cross-shaped with a radial main part and a branch. A radially outer end of the retaining pin 42 is in this case radially inset from the outer surface 28a of the outer ring. Alternatively, the retaining pin 42 could be flush with the outer surface 28a. A first part of the retaining pin is located in the slot 34 of the bushing and a second part of the retaining pin is mounted in the slot of the insulating insert and a third part of the retaining pin is located in the slot 36 of the second ring.

The retaining pin 42 extends from the support member 44. The retaining pin 42 extends radially outwards from the support member 44. The support member 44 is in the form of a portion extending circumferentially over a limited angular sector, which may for example be between 5°and 20°.

The anti-rotation device 32 also comprises two beads 46 extending radially outward from the support member 44. The beads 46 are located circumferentially on either side of the retaining pin 42. As illustrated in FIG. 3, the beads 46 extend into the groove 14f of the outer ring 14 of the bearing. The beads 46 are engaged inside the groove 14f and cooperate with it by snap-fitting to ensure the axial retention of the anti-rotation device relative to the outer ring 14. Each bead 46 bears against a wall of the groove 14f in the axial direction to ensure this axial retention. The beads 46 form means for securing the anti-rotation device 32 to the outer ring 14.

In the exemplary embodiment illustrated, the anti-rotation device 32 is flush with the end face 28d of the bushing, the end face 30d of the insulating insert, and the end face 14d of the outer ring. Alternatively, the anti-rotation device 32 could be set back from the end faces 28d, 30d, 14d of the bushing, the insulating insert and the outer ring, or alternatively project axially from these faces.

As indicated above, the bearing device also includes a second anti-rotation device 33. The second anti-rotation device 33 is mounted at a location on the bearing device diametrically opposite the first anti-rotation device 32 and is identical to the first anti-rotation device. The anti-rotation device 33 is mounted on the bushing 28, the insulating insert 30 and the outer ring 14 in the same way as the anti-rotation device 32, and this mounting will not be described in more detail.

The first and second anti-rotation devices 32, 33 are in this case made of electrically insulating material. The anti-rotation devices 32, 33 can for example be made of a synthetic material, such as PEEK or PA46, or else be made of an elastomeric material, such as rubber. Alternatively, the anti-rotation devices 32, 33 could be made of electrically conductive material and surrounded, at least at one end, by an electrically insulating material.

The bearing device is manufactured as follows.

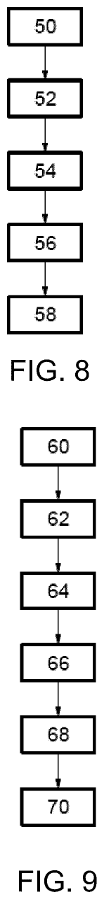

In a first step 50 illustrated in FIG. 8, the slot 34 and the diametrically opposite slot (not referenced) of the bushing 28 are machined. The slot 36 and the diametrically opposite slot (not referenced) of the outer ring 14 of the bearing are also machined.

In a second successive step 52, the first and second anti-rotation devices 32, 33 are mounted on the outer ring 14 by simple axial thrust in order to snap-fit them into the groove 14f of the ring.

In a third successive step 54, the bearing 10, or just the outer ring 14, and the bushing 28 are mounted inside a mold that is provided for overmolding the insulating insert 30. In this position mounted inside the mold, the bushing 28 is radially spaced apart from the outer ring 14 of the bearing.

In a fourth successive step 56, the insulating insert 30 is overmolded on the outer ring 14 of the bearing, on the bushing 28 and on the anti-rotation devices 32, 33. The slot 40 is formed during the step of overmolding the insulating insert 30.

Then, in a fifth step 58, the unitary assembly formed by the bearing 10, or just the outer ring 14, the bushing 28, the insulating insert 30 and the anti-rotation devices 32, 33 is extracted from the mold.

In another implementation method illustrated in FIG. 9, the following procedure is used to manufacture the bearing device.

In a first step 60, the slot 34 and the diametrically opposite slot (not referenced) of the bushing 28 are machined. The slot 36 and the diametrically opposite slot (not referenced) of the outer ring 14 of the bearing are also machined.

In a second successive step 62, the bearing 10, or just the outer ring 14, and the bushing 28 are mounted inside a mold that is provided for overmolding the insulating insert 30. In this position mounted inside the mold, the bushing 28 is radially spaced apart from the outer ring 14 of the bearing.

In a third successive step 64, the insulating insert 30 is overmolded both on the outer ring 14 of the bearing and on the bushing 28.

Then, in a fourth successive step 66, the unitary assembly formed by the bearing 10, or just the outer ring 14, the bushing 28, and the insulating insert 30 is extracted from the mold.

Then, in a fifth successive step 68, the slot 40 and the diametrically opposite slot (not referenced) of the insulating insert are machined. Alternatively, the impressions of these slots could be obtained directly inside the mold.

Finally, in a sixth step 70, the first and second anti-rotation devices 32, 33 are mounted on the outer ring 14.

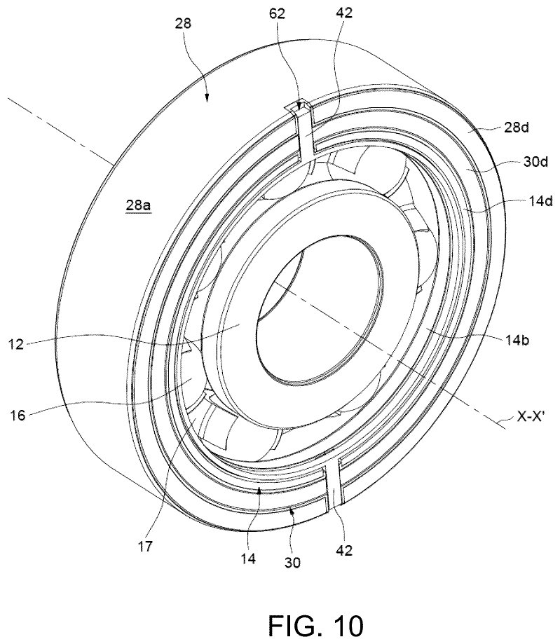

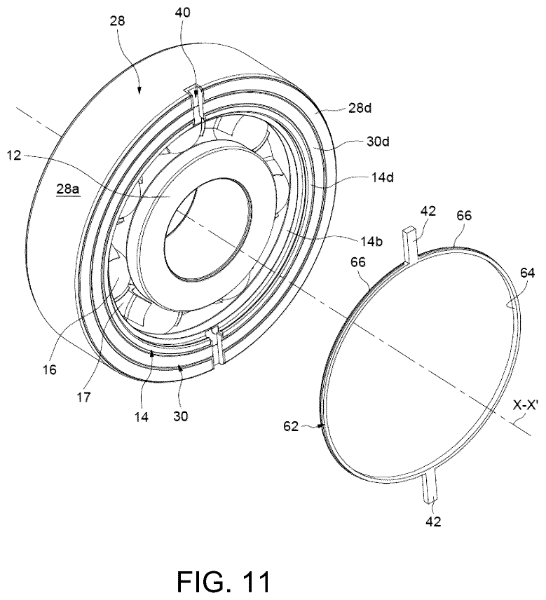

The exemplary embodiment illustrated in FIGS. 10 and 11, in which identical elements bear the same references, differs from the first example in that the device comprises a single anti-rotation device 62 to constrain the bushing 28, the insulating insert 30 and the outer ring 14 of the bearing to rotate together.

The anti-rotation device 62 comprises an annular support 64 seated in the bore 14b of the outer ring of the bearing and two retaining pins 42 carried by the support. More precisely, the support 64 is seated in the groove 14f of the bore 14b. The retaining pins 42 are diametrically opposed. In this example, the retaining pins 42 are each in the form of a parallel key. The retaining pins 42 are mounted in the slots of the bushing, the insulating insert and the outer ring in a manner similar to the first example.

The anti-rotation device 62 also comprises two beads 66 extending radially from the support 64. The beads 66 extend radially outwards from the support 64. Each bead 66 extends circumferentially on the support 64 from one retaining pin 42 to the other. Each bead 66 is continuous in the circumferential direction from one retaining pin 42 to the other. Alternatively, it could be possible to provide beads spaced apart from each other in the circumferential direction, from one retaining pin 42 to the other.

In a similar manner to the first example, the beads 66 extend inside the groove 14f of the outer ring 14 of the bearing to ensure axial retention of the anti-rotation device 62 relative to the outer ring.

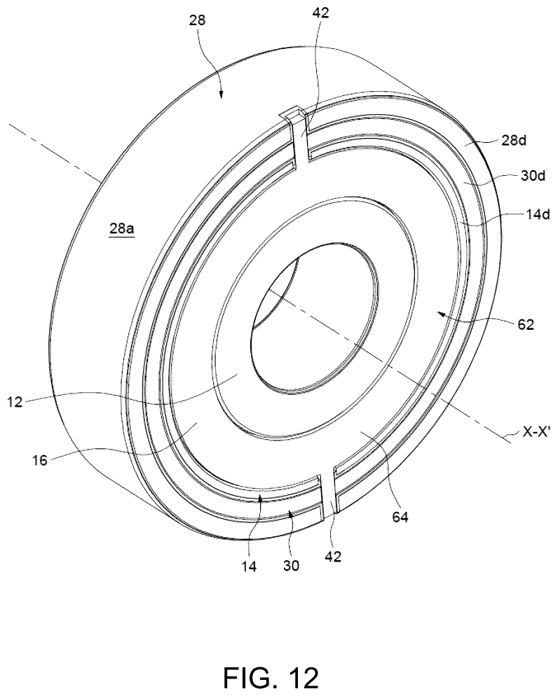

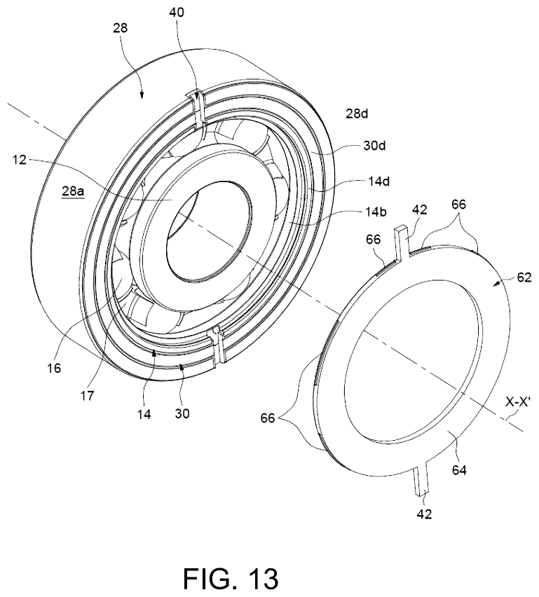

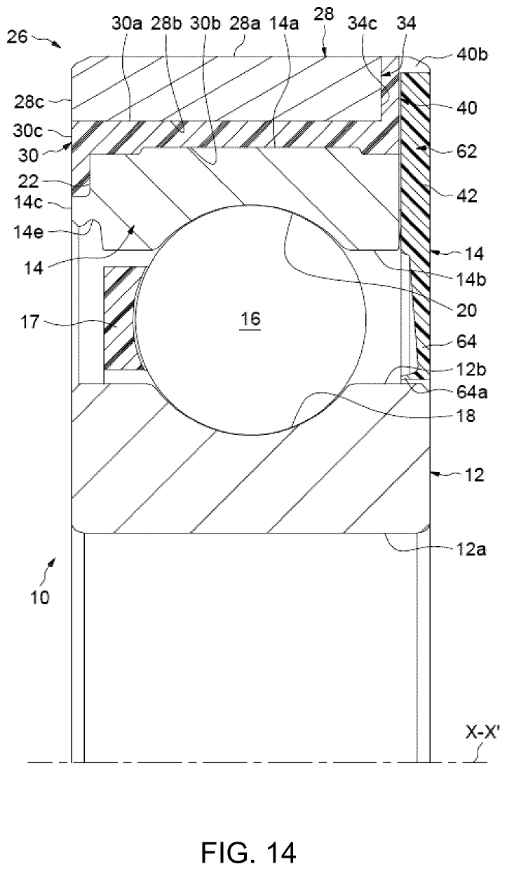

The exemplary embodiment illustrated in FIGS. 12 to 14, in which identical elements bear the same references, differs mainly from the second example in that the support 64 of the anti-rotation device 62 has a larger radial dimension. The support 64 extends nearly as far as the outer surface 12b of the inner ring of the bearing to form therewith a dynamic annular seal by means of a narrow gap. The support 64 is also provided, at its lower end, with a lip 64a extending axially inwards to extend the narrow gap formed between the support 64 and the inner ring 12 of the bearing.

In the exemplary embodiment illustrated, the support 64 forms a dynamic seal with the inner ring 12 by means of a narrow gap. Alternatively, the support 64 could form a dynamic seal with the inner ring 12 by friction contact.

In this exemplary embodiment, beads 46 spaced apart from each other in the circumferential direction are provided circumferentially on both sides of the retaining pins 42.

In the exemplary embodiments illustrated, the anti-rotation device is retained axially on the outer ring of the bearing. Alternatively or in combination, the anti-rotation device could be retained axially on the outer surface of the bushing. In another variant, the anti-rotation device could be retained axially on the insulating insert.

In the exemplary embodiments illustrated, the first ring 12 of the bearing is the inner ring and the second ring 14, on which the insulating insert 30 is overmolded, is the outer ring.

Alternatively, an inverted arrangement may be used, in which the second ring 14, on which the insulating insert 30 is overmolded, is the inner ring. In this case, the insulating sleeve is located in the bore 12a of the inner ring. The insulating insert is then interposed radially between the bore 12a of the inner ring and the outer surface of the bushing. The insulating insert is overmolded on the inner ring and at least on the outer surface of the bushing. The bore of the bushing delimits the bore of the bearing device. With this inverted arrangement, the anti-rotation device is retained axially on the inner ring of the bearing. Alternatively or in combination, the anti-rotation device could be retained axially on the bore of the bushing. In another variant, the anti-rotation device could be retained axially on the insulating insert.

In the described exemplary embodiments, the bearing of the device has a single row of rolling elements. As a variant, the bearing can be provided with several rows of rolling elements. In addition, the rolling bearing may comprise types of rolling elements other than balls, for example rollers. In another variant, the bearing may be a plain bearing with no rolling elements.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved insulated bearings.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is clamed is:

1. A bearing device comprising:
a bearing including a first ring and a second ring configured to rotate relative to each other, the second ring having a first cylindrical surface and a second cylindrical surface radially spaced from the first cylindrical surface,
a bushing having an axial length and a first cylindrical surface and a second cylindrical surface radially spaced from the first cylindrical surface of the bushing,
an electrically insulating insert overmolded between and connecting the first cylindrical surface of the bushing and the second cylindrical surface of the second ring, and
at least one key,
wherein the bushing includes at least one radial slot, the insulating insert includes at least one radial slot and the second ring includes at least one radial slot, the at least one radial slot of the bushing being at least partially aligned with the at least one radial slot of the insulating insert and the at least one radial slot of the insulating insert being at least partially aligned with the at least one radial slot of the second ring,
wherein the at least one key includes:
a retaining pin having a first part mounted in the at least one radial slot of the bushing and a second part mounted in the at least one radial slot of the insulating insert and a third part mounted in the at least one radial slot of the second ring,
at least one circumferentially extending support member connected to the retaining pin, and
at least one radial bead on the circumferentially extending support member projecting into a radially facing groove to form an interference fit and hold the retaining pin in the at least one radial slot of the bushing and in the at least one radial slot of insulating insert and in the at least one radial slot of the second ring.

2. The bearing device according to claim 1,
wherein the at least one circumferentially extending support member is connected to a radially inner end of the retaining pin, and
wherein the radially facing groove is located in the first cylindrical surface of the second ring.

3. The bearing device according to claim 2,
wherein the at least one radial bead is connected to the radially facing groove by a snap-fit.

4. The bearing device according to claim 2,
wherein a portion of the insulating insert extends into the at least one radial slot of the bushing and covers at least one wall of the at least one radial slot of the bushing.

5. The bearing device according to claim 2,
wherein the at least one key comprises a first key and a second key,
wherein the at least one radial slot of the bushing comprises a first radial slot and a second radial slot,
wherein the at least one radial slot of the insulating insert comprises a first radial slot and a second radial slot, and
wherein the at least one radial slot of the second ring comprises a first radial slot and a second radial slot.

6. The bearing device according to claim 5,
wherein the at least one circumferentially extending support member is annular.

7. The bearing device according to claim 2,
wherein the at least one circumferentially extending support member is annular.

8. The bearing device according to claim 7,
wherein a radial inner edge of the at least one circumferentially extending support member is located radially inward of the first cylindrical surface of the second ring.

9. The bearing device according to claim 2,
wherein the at least one radial slot of the bushing is open in an axial direction,
wherein the at least one radial slot of the insulating insert is open in the axial direction, and
wherein the at least one radial slot in the second ring is open in the axial direction.

10. The bearing device according to claim 2,
wherein the at least one key comprises an electrically insulating material.

11. The bearing device according to claim 2,
wherein the at least one key comprises a first key,
wherein the at least one circumferentially extending support member comprises a first circumferentially extending support member on the first key and a second circumferentially extending support member on the first key radially spaced from the first circumferentially extending support member on the first key.

12. An electric motor comprising:
a housing,
a shaft, and
at least one bearing device according claim 11, mounted radially between the housing and the shaft.

13. An electric motor comprising:
a housing,
a shaft, and
at least one bearing device according claim 2, mounted radially between the housing and the shaft.
